(19) United States
(12) Patent Application Publication
(10) Pub. No.: US 2026/0260360 A1
(43) Pub. Date: Sep. 3, 2026

(54) METHOD AND APPARATUS FOR INSTANCE SEGMENTATION USING TEXT-BASED SEMANTIC INFORMATION EXTRACTION

(71) Applicant: ELECTRONICS AND TELECOMMUNICATIONS RESEARCH INSTITUTE, Daejeon (KR)

(72) Inventors: Hong Kee KIM, Daejeon (KR); Ji Hyung LEE, Daejeon (KR); Sung Hyun KIM, Daejeon (KR); Kyung Ho JANG, Daejeon (KR); Sang Pil KIM, Seoul (KR); Won Seok ROH, Seoul (KR); Hwan Hee JUNG, Seoul (KR)

(73) Assignee: ELECTRONICS AND TELECOMMUNICATIONS RESEARCH INSTITUTE, Daejeon (KR)

(21) Appl. No.: 19/551,273

(22) Filed: Feb. 26, 2026

(30) Foreign Application Priority Data
Feb. 28, 2025 (KR) 10-2025-0026778

(51) Int. Cl. G06T 7/12; G06N 3/048; G06T 7/194; G06V 10/74; G06V 10/77; G06V 10/80

(52) U.S. Cl. CPC G06T 7/12; G06N 3/048; G06T 7/194; G06V 10/761; G06V 10/7715; G06V 10/806

(57) ABSTRACT

A method and an apparatus for instance segmentation using text-based semantic information extraction. An embodiment of the present disclosure provides a method for instance segmentation for generating a three-dimensional instance mask by receiving point cloud data, the method including: voxelizing the point cloud data; extracting resolution-specific feature maps from the voxelized point cloud data; predicting a binary foreground mask using at least one first feature map and instance queries; refining the instance queries using at least one second feature map; fusing semantic features of individual instances, extracted using a pre-trained text encoder, into the refined instance queries; and generating, based on the fused instance queries, a three-dimensional instance mask reflecting the semantic features.

### CROSS-REFERENCE TO RELATED APPLICATION

The present application claims priority to Korean Patent Application No. 10-2025-0026778, filed on Feb. 28, 2025 in the Korea Intellectual Property Office, the entire contents of which are incorporated herein by reference.

### TECHNICAL FIELD

The present disclosure relates to a method and apparatus for instance segmentation using text-based semantic information extraction. More specifically, the present disclosure presents a deep learning-based method for three-dimensional instance segmentation task by utilizing an indoor space scan dataset in a point cloud format.

### BACKGROUND

The statements in this section merely provide background information related to the present disclosure and do not necessarily constitute prior art.

In recent years, as the availability of LiDAR sensors and depth cameras increases, the collection and utilization of three-dimensional scan data using them has become more active. In particular, with the advent of LiDAR sensor photography using mobile devices, it has become possible to easily collect RGB-D scan data in various indoor spaces, and study for recognizing, classifying, and segmenting an object based on this is continuously underway. 3D scene understanding study based on point cloud data types may serve as a very important factor in the field of virtual and augmented reality content, autonomous driving technology, and robot navigation.

Conventional study on instance segmentation has been actively conducted mainly in the field of two-dimensional images, and numerous attempts have been made to extend the methodology used for 2D object segmentation and apply it to three-dimensional data such as a point cloud. Point cloud data generally has very sparse distribution and unordered structural characteristics, causing many difficulties in various data processing steps, including object segmentation tasks. Therefore, in study on the three-dimensional indoor space instance segmentation conducted to date, predictions have been made utilizing only the geometric information and spatial information of the point cloud, and many developments have been made so that more accurate geometric information may be extracted and learned.

Among the conventional study on representative object segmentation, there are many technologies of specifying an object by predicting a centroid of the object, or recognizing and specifying a range of the object by predicting a 3D bounding box, and methodologies for predicting a foreground mask of an object by grouping points of the same object by performing clustering task on a point cloud have been developed.

The three-dimensional instance segmentation task simultaneously performs semantic classification (e.g., bed, desk, window) and instance segmentation (e.g., desk 1, desk 2, desk 3) corresponding to each point, and for this purpose, it is important to distinguish individual objects and accurately classify categories based on characteristics of the objects. For this task, recent studies effectively extract spatial features and information on a sparse point cloud through a 3D sparse convolutional layer based on a deep neural network, and utilize the spatial features and information for instance segmentation. In general, each point includes 3D coordinates and color channels (RGB channels), thereby taking a form of six or more dimensions, high-dimensional features may be extracted and spatial latent features may be obtained through a 3D sparse convolutional network. The spatial features thus obtained are then converted into object-specific features by iteratively passing through a network of transformer architecture. The data in units of objects derived from the transformer network is then used for semantic multi-classification via multi-layer perceptron (MLP) and is used to extract binary masks representing point-by-point objects. Networks based on such transformer architecture exhibit high performance and are dominantly used in instance segmentation tasks.

Indoor space datasets mainly used in instance segmentation tasks include ScanNet and stanford large-scale 3D indoor spaces (S3DIS). The indoor space dataset is an RGB-D scan dataset obtained by photographing various indoor spaces such as classrooms, offices, and bedrooms, and consists of point cloud data including three-dimensional coordinates, RGB color channels, surface normal vectors, and the like. Additionally, mesh data, 2D images, depth images, and the like are provided.

### SUMMARY

The present disclosure is directed to introducing a module capable of additionally providing semantic information of object-specific category text to a conventional object segmentation network that utilizes only geometric information, thereby improving overall object classification performance.

The technical objects of the present disclosure are not limited to those described above, and other technical objects not mentioned above may be understood clearly by those skilled in the art from the descriptions given below.

An embodiment of the present disclosure provides a method for instance segmentation for generating a three-dimensional instance mask by receiving point cloud data, the method including: voxelizing the point cloud data; extracting resolution-specific feature maps from the voxelized point cloud data; predicting a binary foreground mask using at least one first feature map and instance queries; refining the instance queries using at least one second feature map; fusing semantic features of individual instances, extracted using a pre-trained text encoder, into the refined instance queries; and generating, based on the fused instance queries, a three-dimensional instance mask reflecting the semantic features.

Another embodiment of the present disclosure provides an apparatus including: at least one memory; and at least one processor, wherein the at least one processor is configured to execute instructions to: voxelize the point cloud data; extract resolution-specific feature maps from the voxelized point cloud data; predict a binary foreground mask using at least one first feature map and instance queries; refine the instance queries using at least one second feature map; fuse semantic features of individual instances, extracted using a pre-trained text encoder, into the refined instance queries; and generate, based on the fused instance queries, a three-dimensional instance mask reflecting the semantic features.

According to an embodiment of the present disclosure, a semantic feature may be extracted from category text (e.g., “bed”, “chair”) of each object by using a vision-language model (VLM) such as contrastive language-image pre-training (CLIP), and the semantic feature may be appropriately fused with an object feature of an existing transformer-based network to supplement semantic information and improve object classification performance.

According to an embodiment of the present disclosure, information that cannot be obtained from the point cloud may be extracted from the text and further utilized to clearly distinguish semantically different objects having similar appearances (e.g., chair, sofa), which may improve the overall performance of the network.

The technical effects of the present disclosure are not limited to the technical effects described above, and other technical effects not mentioned herein may be understood to those skilled in the art to which the present disclosure belongs from the description below.

### BRIEF DESCRIPTION OF THE DRAWINGS

FIG. 1 is a schematic block diagram of an apparatus for instance segmentation according to an embodiment of the present disclosure.

FIG. 2 is a diagram illustrating an example in which a three-dimensional sparse convolutional network extracts feature maps at various layers and applies skip connections, according to an embodiment of the present disclosure.

FIG. 3 is a block diagram illustrating a transformer decoder network according to an embodiment of the present disclosure.

FIG. 4 is a diagram illustrating an operation process of a mask module and a query refinement module according to an embodiment of the present disclosure.

FIG. 5 is a diagram illustrating an operation process of a semantic network according to an embodiment of the present disclosure.

FIG. 6 is a diagram illustrating an example in which latent vectors in a latent space are shown according to an embodiment of the present disclosure.

FIG. 7 is a flowchart illustrating an operation process of an apparatus for instance segmentation according to an embodiment of the present disclosure.

FIG. 8 is a block diagram schematically illustrating an example computing device that may be used to implement a method or apparatus according to the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present invention, and is not intended to represent the only embodiments in which the present invention may be practiced.

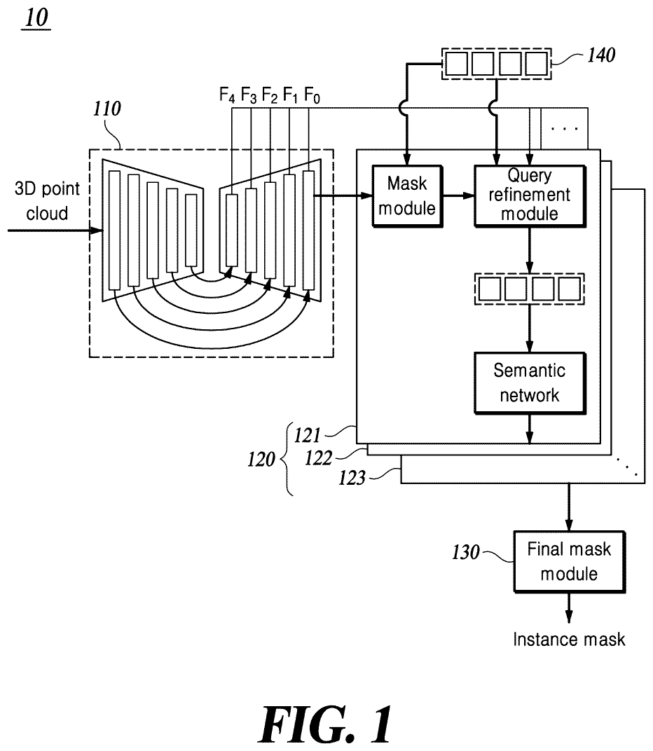

FIG. 1 is a schematic block diagram of an apparatus 10 for instance segmentation according to an embodiment of the present disclosure.

The apparatus 10 for the instance segmentation may include all or some of a three-dimensional sparse convolutional network 110, a transformer decoder network 120, and a final mask module 130. The components shown in FIG. 1 represent functionally distinct elements, and at least one component may be implemented in an integrated form in an actual physical environment.

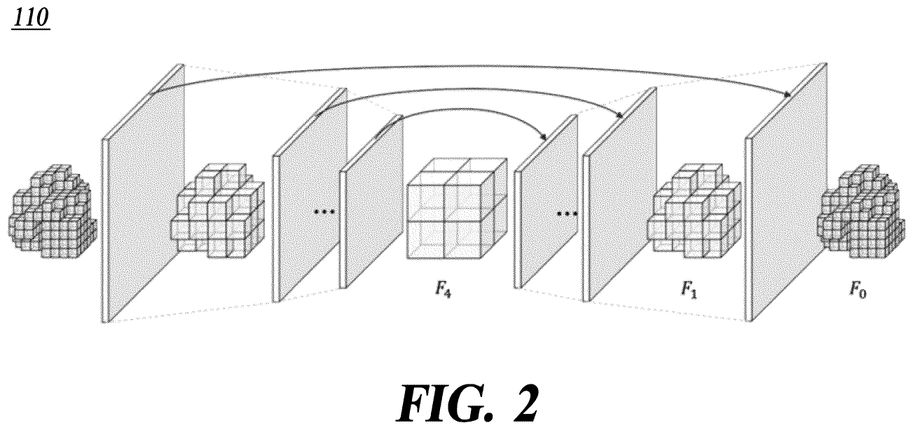

The three-dimensional sparse convolutional network 110 may be configured in a symmetric U-Net architecture. The three-dimensional sparse convolutional network 110 may receive point cloud data as input. Here, the point cloud data may include at least one or more of three-dimensional coordinates, RGB color channels, surface normal vectors, and the like. In addition, the point cloud data may be extracted from an RGB-D scan dataset obtained by photographing various indoor spaces such as classrooms, offices, and bedrooms. The three-dimensional sparse convolutional network 110 voxelizes the original point cloud data having continuous coordinates and converts it into a structured format to enable convolution operations. The color of a voxel may be designated as the average color of the points included in that voxel. All blocks of the three-dimensional sparse convolutional network 110 are composed of residual convolution blocks, and a feature map of each layer within the symmetric U-Net architecture are connected using a skip connection. However, details related thereto will be described in detail with reference to FIG. 2.

The transformer decoder network 120 predicts a binary object mask using the feature maps extracted from the three-dimensional sparse convolutional network 110 and refines instance queries 140. The transformer decoder network 120 may include one or more decoder layers. In addition, the transformer decoder network 120 may also fuse semantic features of individual instances, extracted using a pre-trained text encoder, into the refined instance queries.

The final mask module 130 generates, based on the fused instance queries, a three-dimensional instance mask (3D instance mask) reflecting semantic features of the objects.

FIG. 2 is a diagram illustrating an example in which a three-dimensional sparse convolutional network 110 extracts feature maps at various layers and applies skip connections, according to an embodiment of the present disclosure. To illustrate FIG. 2, reference may be made to in conjunction with FIG. 1.

Referring to FIG. 2, the three-dimensional sparse convolutional network 110 is composed of a total of five layers. The resolution of each layer is gradually reduced through average pooling. Each layer may be composed of a plurality of channels, and the dimensions of the channels may be composed in the order of 96, 96, 128, 256, and 256.

For example, in a first layer of the three-dimensional sparse convolutional network 110, data may be represented by 96 channels, and as the layer depth increases, more channels 128, 256, etc. may be used to extract more complex features. That is, the three-dimensional sparse convolutional network 110 may learn both local characteristics and global characteristics by extracting the feature maps F0 to F4 of different resolutions for each layer. The first feature map F0, which is the highest resolution feature map, is used to predict a binary object mask for the entire voxel, and second feature maps F1 to F4 are used to refine queries in the transformer decoder network 120.

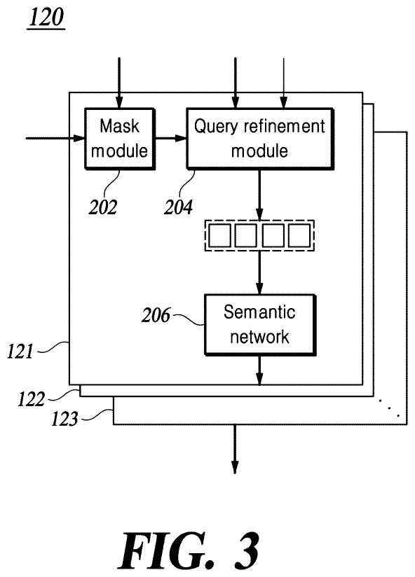

FIG. 3 is a block diagram illustrating a transformer decoder network 120 according to an embodiment of the present disclosure. To illustrate FIG. 3, reference may be made to in conjunction with FIG. 1.

The transformer decoder network 120 may include a plurality of layers 121, 122, 123. Each layer 121, 122, 123 may include all or some of a mask module 202, a query refinement module 204, and a semantic network 206.

The mask module 202 may generate the binary object mask for the entire voxel. Here, the binary object mask may be a binary foreground mask.

The query refinement module 204 refines the queries using the second feature maps F1 to F4. The query refinement module 204 is based on a transformer architecture. The query refinement module 204 uses cross attention, self attention, and feed forward blocks, and may improve network performance by switching the order of the cross attention and self attention.

The semantic network 206 may fuse semantic features of individual instances, extracted using a pre-trained language model, into the refined instance queries.

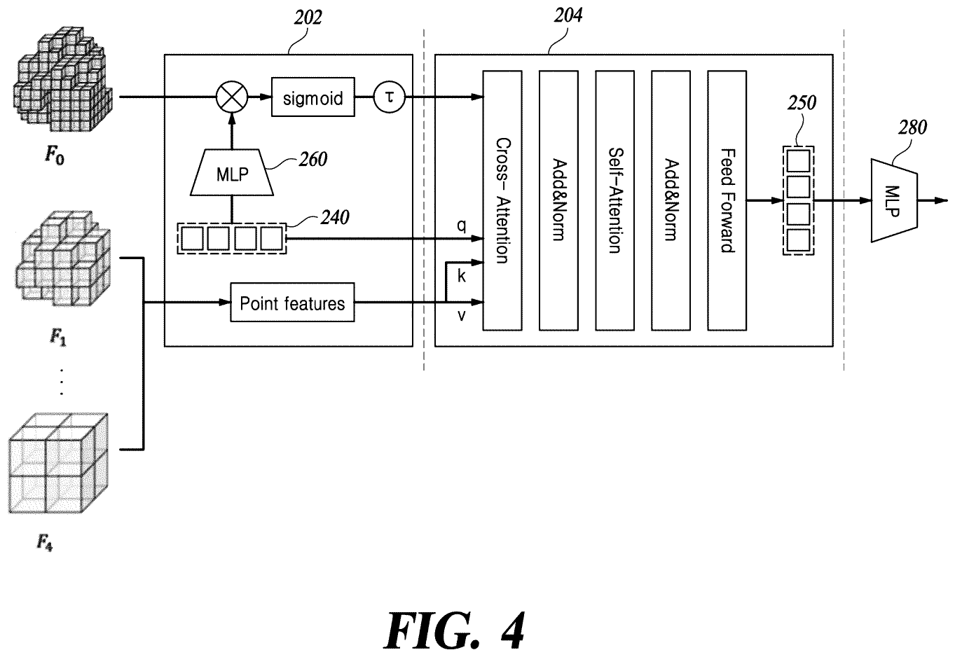

FIG. 4 is a diagram illustrating an operation process of a mask module 202 and a query refinement module 204 according to an embodiment of the present disclosure. To illustrate FIG. 4, reference may be made to in conjunction with FIG. 1.

The mask module 202 may generate the binary object mask for the entire voxel. Here, the binary object mask may be the binary foreground mask.

The operation process of the mask module 202 is as follows.

Referring to FIG. 4, the mask module 202 receives the highest resolution feature map F0 and an input query 240. Here, the input query 240 may be an instance query 140 or a query output from a previous decoder layer 121, 122, 123. The input query 240 may include Nk vectors each having a D dimension. The mask module 202 performs an inner product operation using the feature map F0 that has passed through the MLP 260 and the input query 240. The mask module 202 performs the inner product operation to calculate the object similarity for each voxel. The mask module 202 calculates the object similarity to generate a similarity matrix. The generated similarity matrix is converted to the binary foreground mask via a sigmoid activation function and a preset threshold. The preset threshold may be 0.5. The generated binary foreground mask is used for attention masking in the query refinement module 204.

Meanwhile, the queries that have passed through a class prediction MLP 280 may predict a probability of a corresponding semantic class for each object through a softmax activation function. Here, the meaning of predicting the probability of the semantic class means identifying a type of object (e.g., a chair, a desk, a sofa) segmented by voxels. That is, the present disclosure aims not only to distinguish the shape, but also to understand the meaning and category of the object. Since there may be objects that are not included in the actual label information, the MLP 280 may perform multi-class classification for a total of 19 classes by adding a “no corresponding object” label to the 18 classes.

The query refinement module 204 performs an operation of refining the queries of the transformer decoder layers 121, 122, 123. The second feature maps F1 to F4, the instance query 140, and the binary foreground mask extracted from the mask module 202 are inputs to the query refinement module 204. The query refinement module 204 refines the queries with reference to the input feature maps. Although the query refinement module 204 follows the structure of a general transformer model, the present disclosure applies the cross attention block and the self attention block in reverse order.

In other words, the query refinement module 204 may include one or more decoder blocks. The decoder block maps the instance queries 140 to queries of the cross attention layer, and maps the second feature maps F1 to F4 to keys and values of the cross attention layer. The cross attention layer may remove the background by applying the binary foreground mask to an attention score matrix generated based on the queries and the keys.

An operation process of the query refinement module 204 is as follows.

The query refinement module 204 generates a first attended instance query based on the cross attention between the instance queries 140 and the second feature maps F1 to F4. The query refinement module 204 generates a second attended instance query based on the self attention for the first attended instance query. Next, the query refinement module 204 may generate refined queries by applying the second attended instance query to a feedforward. In the cross attention for the instance queries, the feature maps F1 to F4 are mapped to keys and values by passing through a separate MLP, and the binary foreground mask is added in the process of computation with the queries to remove background points and focus on the foreground points. The query refinement module 204 is subject to positional encoding, as in a general transformer model, where Fourier encoding is used. Position information of each query is embedded in the input queries 240, and voxel coordinates are embedded in the keys. The query refinement is composed of 4 or 3 decoder layers in one layer depending on the resolution, and a total of 12 query refinement blocks may exist. In other words, the transformer decoder may be composed of a total of 3 layers. Each layer has a form in which the same structure is replicated, and each layer has resolution-specific query refinement blocks. A total of 4 resolution-specific feature maps are inputs to the second feature maps F1 to F4, so that a total of 4 query refinement blocks may exist in one layer. Since this layer is repeated a total of 3 times, finally 12 query refinement blocks may exist. In addition, the number of voxels of the feature maps F1 to F4 input to the cross attention is set differently in the learning process and the test process. The query refinement module 204 fixes the number of input voxels constantly during learning, and limits the input by adding padding if the number of voxels is insufficient or by sampling only a portion if the number is exceeded. On the other hand, the query refinement module 204 performs the cross attention operation using all input voxels in the test process. Thus, the query refinement module 204 may perform such operation to indirectly provide an effect such as a dropout.

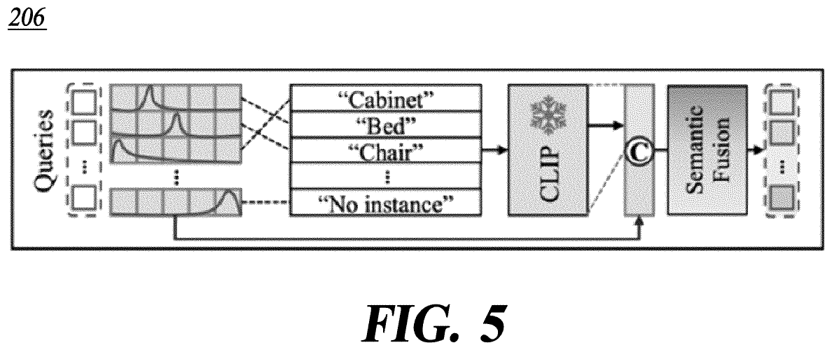

FIG. 5 is a diagram illustrating an operation process of a semantic network 206 according to an embodiment of the present disclosure. To illustrate FIG. 5, reference may be made to in conjunction with FIG. 3 and FIG. 4.

Referring to FIG. 5, a process in which the semantic network 206 determines a category text of the object, and then fuses a semantic feature vector extracted from the pre-trained language model is shown.

The semantic network 206 utilizes semantic information of the category corresponding to each object to enhance object features. A classifier may predict a category represented by each query using the object queries 250 extracted from the query refinement module 204. For example, referring to FIG. 3, the MLP 280 may estimate the class using the object queries 250. The classifier here may be the MLP 280.

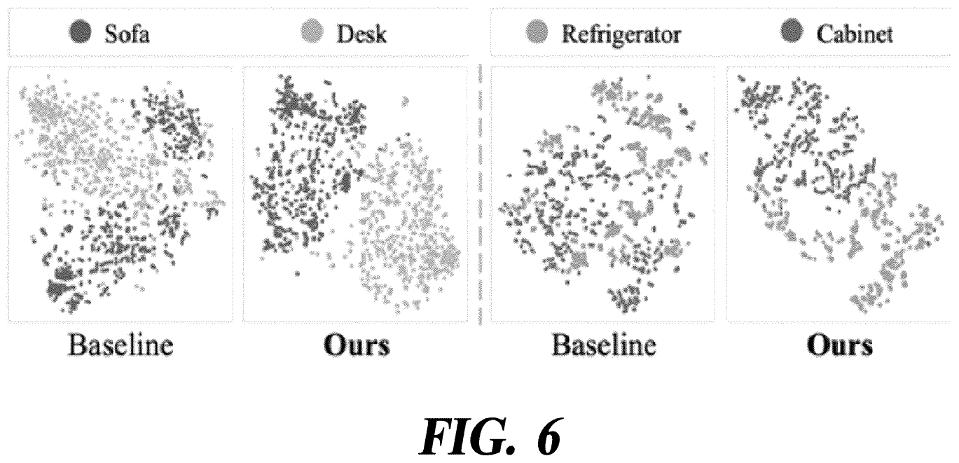

The semantic network 206 may use the category text as input to the pre-trained language model. Here, the pre-trained language model may be contrastive language-image pre-training (CLIP). The semantic network 206 may extract features from the text using a text encoder included in the CLIP. That is, the semantic network 206 may extract the feature vector from the category text representing the class of an individual object using the pre-trained text encoder. The extracted feature vector contains semantic information, and the extracted feature vector is concatenated with original object features of the existing query. Next, object features extracted from the point cloud and semantic features extracted from the text are fused and converted into a new latent space by using a semantic fusion composed of a learnable MLP. In the new latent space, a clearer separation of objects becomes possible than in the feature space of the point cloud, which may be confirmed from the visualization result of FIG. 6 shown below.

In the learning process, the language model used for feature extraction is frozen so that weight updates are not made due to error backpropagation, and may only play a role of extracting semantic features using pre-learned knowledge. Therefore, the additional deep neural network is not involved in the learning, the amount of computation is small, and the difference in learning time is small compared to the existing model, so that it may be efficiently utilized. The classifier may accurately map object features to semantic categories (e.g., chair, desk) through repeated learning. Thus, the classifier allows semantic information to be extracted correctly. In addition, the semantic fusion is learned to map the object features and the semantic features into a latent space where they may best be distinguished, and as the learning progresses, the ability to distinguish between objects with similar appearances that were previously ambiguous, may be improved.

FIG. 6 is a diagram illustrating an example in which latent vectors in a latent space are shown according to an embodiment of the present disclosure.

Referring to FIG. 6, each object (sofa, desk, refrigerator, and cabinet) is shown as a latent vector in the latent space.

Unlike the existing model, when using the present disclosure, since the latent vectors are concentratedly distributed in a specific region, it is possible to distinguish objects clearly.

In addition, in the present disclosure, the additional deep neural network is not involved in the learning, the amount of computation is small, and the difference in learning time is small compared to the existing model, so that it may be efficiently utilized.

Hereinafter, the three-dimensional indoor space instance segmentation performance according to an embodiment of the present disclosure is as follows. Table 1 below shows the evaluation of instance segmentation performance.

The experimental results obtained using the validation set of the ScanNetV2 dataset and the Area5 set of the S3DIS dataset are shown. A mean average precision (mAP) score is a key indicator used to evaluate the performance of a network in 2D image or 3D point cloud based instance segmentation tasks in the field of computer vision. Here, a higher mAP indicates that the model has more accurately identified and distinguished the objects. Referring to Table 1 below, it may be confirmed that using the present disclosure shows better performance than existing networks.

TABLE 1

| | |
|---|---|
| ScanNet Val | S3DIS Area5 |

| Method | mAP | mAP₅₀ | mAP | mAP₅₀ |
|---|---|---|---|---|
| GSPN | 19.3 | 37.8 | — | — |
| 3D-SIS | — | 18.7 | — | — |
| MTML | 20.3 | 40.2 | — | — |
| 3D-MPA | 35.5 | 59.1 | — | — |
| DyCo3D | 35.4 | 57.6 | — | — |
| PointGroup | 34.8 | 56.7 | — | 57.8 |
| MaskGroup | 42.0 | 63.3 | — | 65.0 |
| OccuSeg | 44.2 | 60.7 | — | — |
| SSTNet | 49.4 | 64.3 | 42.7 | 59.3 |
| HAIS | 43.5 | 64.1 | — | — |
| SoftGroup | 46.0 | 67.6 | 51.6 | 66.1 |
| Mask3D | 55.2 | 73.7 | 56.6 | 68.4 |
| Ours | 59.7 | 76.6 | 58.1 | 70.1 |

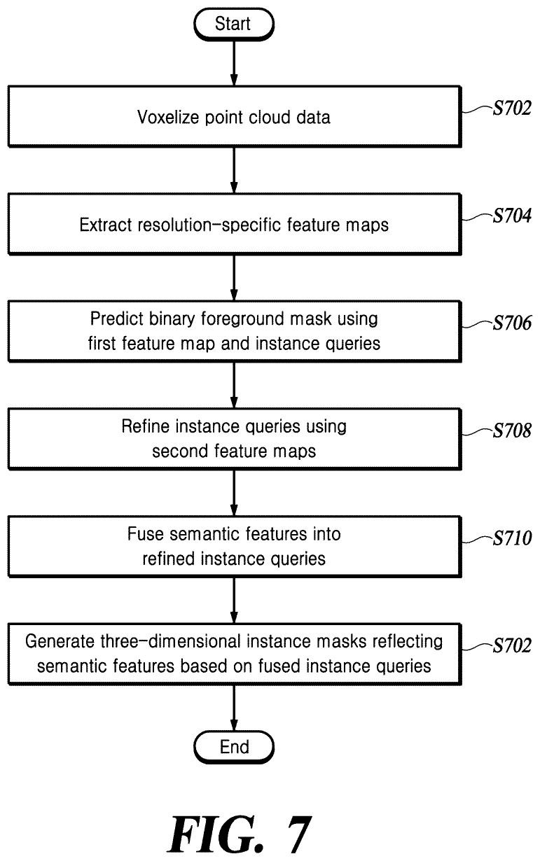

FIG. 7 is a flowchart illustrating an operation process of an apparatus 10 for instance segmentation according to an embodiment of the present disclosure.

The three-dimensional sparse convolutional network 110 may receive point cloud data as input. Here, the point cloud data may include at least one or more of three-dimensional coordinates, RGB color channels, surface normal vectors, and the like. The three-dimensional sparse convolutional network 110 voxelizes the original point cloud data having continuous coordinates and converts it into the structured format to enable convolution operations (S702).

The three-dimensional sparse convolutional network 110 may extract the resolution-specific feature maps F0 to F4 from the voxelized point cloud data (S704).

The extracted feature maps may be divided into a first feature map and a second feature map. Here, the first feature map may be F0. The second feature map may include F1 to F4.

The mask module 202 may predict the binary foreground mask using the at least one first feature map and the instance queries (S706).

The query refinement module 204 may refine the instance queries using the at least one second feature map (S708). The second feature maps F1 to F4, the instance queries 140, and the binary foreground mask extracted from the mask module 202 are inputs to the query refinement module 204. The query refinement module 204 generates the first attended instance query based on the cross attention between the instance queries 140 and the second feature maps F1 to F4. The query refinement module 204 generates the second attended instance query based on the self attention for the first attended instance query. Next, the query refinement module 204 may generate refined queries by applying the second attended instance query to the feedforward.

The semantic network 206 may fuse semantic features of individual instances, extracted using the pre-trained text encoder, into the refined instance queries (S710).

The final mask module 130 generates, based on the fused instance queries, the three-dimensional instance mask reflecting semantic features of the objects (S712).

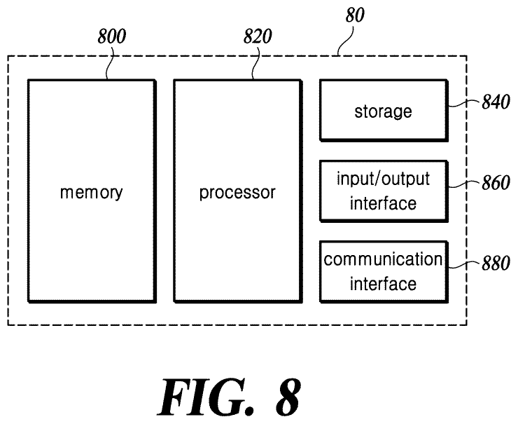

FIG. 8 is a block diagram schematically illustrating an example computing device that may be used to implement a method or apparatus according to the present disclosure.

The computing device 80 may include some or all of memory 800, processor 820, storage 840, input/output interface 860, and communication interface 880. The computing device 80 may be a stationary computing device such as a desktop computer or server, as well as a mobile computing device such as laptop computer or smart phone. The computing device 80 may also include any specialized hardware accelerator capable of processing operations on an artificial intelligence model in an efficient manner. For example, the computing device 80 may include a graphics processing unit (GPU), a tensor processing unit (TPU), or a neural processing unit (NPU).

The memory 800 may store a program that causes the processor 820 to perform a method or an operation according to various embodiments of the present disclosure. For example, the program may include a plurality of instructions executable by the processor 820, and the aforementioned method or operation may be performed by executing the plurality of instructions by the processor 820. The memory 800 may be a single memory or a plurality of memories. In this case, information required to perform the method or operation according to various embodiments of the present disclosure may be stored in the single memory or may be divided and stored in the plurality of memories. When the memory 800 is composed of a plurality of memories, the plurality of memories may be physically separated. The memory 800 may include at least one of a volatile memory and a non-volatile memory. The volatile memory includes a static random access memory (SRAM), a dynamic random access memory (DRAM), or the like, and the non-volatile memory includes a flash memory and the like.

The processor 820 may include at least one core capable of executing at least one instruction. The processor 820 may execute instructions stored in the memory 800. The processor 820 may be a single processor or a plurality of processors.

The storage 840 maintains the stored data even if power supplied to the computing device 80 is cut off. For example, the storage 840 may include non-volatile memory and may also include storage media such as magnetic tape, optical disk, or magnetic disk. A program stored in the storage 840 may be loaded into the memory 800 before being executed by the processor 820. The storage 840 may store a file written in a program language, and a program generated by a compiler or the like from the file may be loaded into the memory 800. The storage 840 may store data to be processed by the processor 820 and/or data processed by the processor 820.

The input/output interface 860 may provide an interface with an input device such as a keyboard or a mouse, and/or an output device such as a display device or a printer. A user may trigger execution of a program by the processor 820 via the input device and/or confirm a processing result of the processor 820 through the output device.

The communication interface 880 may provide access to an external network. The computing device 80 may communicate with other devices via the communication interface 880.

At least some components described in the exemplary embodiments of the present disclosure may be implemented as hardware elements including at least one or a combination of a digital signal processor (DSP), a processor, a controller, an application-specific IC (ASIC), a programmable logic device (FPGA, etc.), or other electronic devices. In addition, at least some functions or processes described in the exemplary embodiments may be implemented by software, and the software may be stored in a recording medium. At least some components, functions, and processes described in the exemplary embodiments of the present disclosure may be implemented by a combination of hardware and software.

The method according to the exemplary embodiments of the present disclosure may be written as a program that may be executed on a computer, and may also be implemented in various recording media such as magnetic storage media, optically readable media, and digital storage media.

Implementations of the various techniques described herein may be implemented in digital electronic circuitry, or in computer hardware, firmware, software, or combinations thereof. The implementations may be implemented as a computer program product, i.e., a computer program tangibly embodied in an information carrier, e.g., a machine-readable storage device (computer-readable medium) or a propagated signal, for processing by, or for controlling the operation of, a data processing apparatus, e.g, a programmable processor, a computer, or multiple computers. A computer program, such as the computer program(s) described above, may be written in any form of programming language, including compiled or interpreted languages, and may be deployed in any form, including as a stand-alone program or as a module, component, subroutine, or other unit suitable for use in a computing environment. The computer program may be deployed to be processed on a single computer or multiple computers at one site or distributed across multiple sites and interconnected by a communication network.

Processors suitable for processing the computer program include, by way of example, both general-purpose and special-purpose microprocessors, and any one or more processors of any kind of digital computer. In general, the processor will receive instructions and data from a read-only memory or a random access memory or both. The elements of the computer may include at least one processor for executing instructions and one or more memory devices for storing instructions and data. In general, the computer may include, or be coupled to receive data from, or transmit data to, or both, one or more mass storage devices for storing data, e.g., magnetic, magneto-optical disks, or optical disks. Information carriers suitable for embodying computer program instructions and data include, by way of example, semiconductor memory devices for example magnetic media such as hard disks, floppy disks, and magnetic tape, optical media such as compact disk read only memory (CD-ROM), digital video disk (DVD), magneto-optical media such as floptical disk, read only memory (ROM), random access memory (RAM), flash memory, erasable programmable ROM (EPROM), electrically erasable programmable ROM (EEPROM), and the like. The processor and memory may be supplemented by, or incorporated in, special purpose logic circuitry.

The processor may perform an operating system and a software application running on the operating system. In addition, the processor device may access, store, manipulate, process, and generate data in response to execution of the software. For convenience of understanding, although the processor device is sometimes described as being singular, those skilled in the art will appreciate that the processor device may include a plurality of processing elements and/or a plurality of types of processing elements. For example, the processor device may include a plurality of processors or one processor and one controller. Other processing configurations are also possible, such as parallel processors.

In addition, non-transitory computer-readable media may be any available media that may be accessed by a computer, and may include both computer storage media and transmission media.

Although the present specification contains details of many specific implementations, these should not be construed as limiting on the scope of any invention or of anything that may be claimed, but rather as a description of features that may be specific to a particular embodiment of a particular invention. Certain features described herein in the context of individual embodiments may also be implemented in combination in a single embodiment. Conversely, various features described in the context of a single embodiment may also be implemented in multiple embodiments individually or in any suitable subcombination. Furthermore, although features may operate in certain combinations and be initially depicted as so claimed, one or more features from a claimed combination may, in some cases, be excluded from the combination, and the claimed combination may be altered to a subcombination or variation of a subcombination.

Likewise, although operations are depicted in the drawings in a specific order, this should not be understood as requiring that such operations be performed in the specific order shown or in sequential order, or that all the shown operations must be performed, in order to achieve a desirable result. In certain cases, multitasking and parallel processing may be advantageous. In addition, the separation of various device components in the embodiments described above should not be understood as requiring such separation in all embodiments, and it should be understood that the described program components and devices may generally be integrated together into a single software product or packaged into multiple software products.

Meanwhile, the embodiments of the present invention disclosed in the specification and drawings merely present specific examples for better understanding, and are not intended to limit the scope of the present invention. It is obvious to those skilled in the art that other modifications based on the technical ideas of the present invention may be implemented in addition to the embodiments disclosed herein.

The protection scope of the present embodiment should be interpreted by the following claims, and all technical ideas falling within the scope equivalent thereto should be construed as being included in the scope of rights of the present embodiment.

What is claimed is:

1. A method for instance segmentation for generating a three-dimensional instance mask by receiving point cloud data, the method comprising:
voxelizing the point cloud data;
extracting resolution-specific feature maps from the voxelized point cloud data;
predicting a binary foreground mask using at least one first feature map and instance queries;
refining the instance queries using at least one second feature map;
fusing semantic features of individual instances, extracted using a pre-trained text encoder, into the refined instance queries; and
generating, based on the fused instance queries, a three-dimensional instance mask reflecting the semantic features.

2. The method of claim 1, wherein
the point cloud data comprises:
at least one of three-dimensional coordinates, RGB color channels, and normal vectors.

3. The method of claim 1, wherein
the first feature map is of the highest resolution.

4. The method of claim 1, wherein
the instance queries comprise:
Nₖ vectors having a D-dimension.

5. The method of claim 1, wherein
the predicting the binary foreground mask comprises:
performing an inner product operation using the first feature map and the instance queries;
calculating an object similarity for each voxel by the inner product operation;
generating a similarity matrix using the calculated object similarity; and
converting the generated similarity matrix using a sigmoid activation function and a preset threshold.

6. The method of claim 1, wherein
the refining comprises:
generating refined queries by applying the second feature map, the instance queries, and the binary foreground mask to a refinement module based on a transformer architecture.

7. The method of claim 6, wherein
the refinement module comprises one or more decoder blocks,
wherein the decoder block generates a first attended instance query based on cross-attention between the instance queries and the second feature map,
generates a second attended instance query based on self-attention for the first attended instance query, and
generates refined queries by applying the second attended instance query to a feedforward network.

8. The method of claim 7, wherein
the decoder block is configured to:
map the instance queries to queries of a cross-attention layer, and
map the second feature map to keys and values of the cross-attention layer.

9. The method of claim 8, wherein
the cross-attention layer removes background by applying the binary foreground mask to an attention score matrix generated based on the queries and keys.

10. The method of claim 1, wherein
the fusing comprises:
extracting a feature vector from a category text representing a class of an individual object using the pre-trained text encoder;
combining the extracted feature vector with original object features of the existing query; and
fusing object features extracted from the point cloud with the semantic features extracted from the text using a MLP.

11. An apparatus comprising:
at least one memory; and
at least one processor,
wherein the at least one processor is configured to execute instructions to:
voxelize the point cloud data;
extract resolution-specific feature maps from the voxelized point cloud data;
predict a binary foreground mask using at least one first feature map and instance queries;
refine the instance queries using at least one second feature map;
fuse semantic features of individual instances, extracted using a pre-trained text encoder, into the refined instance queries; and
generate, based on the fused instance queries, a three-dimensional instance mask reflecting the semantic features.

12. The apparatus of claim 11, wherein
the point cloud data comprises:
at least one of three-dimensional coordinates, RGB color channels, and normal vectors.

13. The apparatus of claim 11, wherein
the first feature map is of the highest resolution.

14. The apparatus of claim 11, wherein
the instance queries comprise:
Nₖ vectors having a D-dimension.

15. The apparatus of claim 11, wherein
the predicting the binary foreground mask comprises:
performing an inner product operation using the first feature map and the instance queries;
calculating an object similarity for each voxel by the inner product operation;
generating a similarity matrix using the calculated object similarity; and
converting the generated similarity matrix using a sigmoid activation function and a preset threshold.

16. The apparatus of claim 11, wherein
the refining comprises:
generating refined queries by applying the second feature map, the instance queries, and the binary foreground mask to a refinement module based on a transformer architecture.

17. The apparatus of claim 16, wherein
the refinement module comprises one or more decoder blocks,
wherein the decoder block generates a first attended instance query based on cross-attention between the instance queries and the second feature map,
generates a second attended instance query based on self-attention for the first attended instance query, and
generates refined queries by applying the second attended instance query to a feedforward network.

18. The apparatus of claim 17, wherein
the decoder block is configured to:
map the instance queries to queries of a cross-attention layer, and
map the second feature map to keys and values of the cross-attention layer.

19. The apparatus of claim 18, wherein
the cross-attention layer removes background by applying the binary foreground mask to an attention score matrix generated based on the queries and keys.

20. The apparatus of claim 11, wherein
the fusing comprises:
extracting a feature vector from a category text representing a class of an individual object using the pre-trained text encoder;
combining the extracted feature vector with original object features of the existing query; and
fusing object features extracted from the point cloud with the semantic features extracted from the text using a MLP.
